(19) United States
(12) Patent Application Publication
(10) Pub. No.: US 2009/0242331 A1
(43) Pub. Date: Oct. 1, 2009

(54) Reserve dry sump oil tank assembly for a motor vehicle

(75) Inventor: Daniel J. Hommes, Eden, NY (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/059,195

(22) Filed: Mar. 31, 2008

(51) Int. Cl. F16N 31/00; F01M 1/12; F01M 11/00

(52) U.S. Cl. 184/106; 184/6.13; 123/196 R

(57) ABSTRACT

A dry sump oil tank assembly is provided for a vehicle. The dry sump oil tank assembly includes a main oil tank that defines a main outlet aperture. A reserve oil tank defines a reserve outlet aperture. An oil transfer tube connects the main oil tank at the main outlet aperture to the reserve oil tank at the reserve outlet aperture. The reserve oil tank is shaped to fit between a frame rail and a fender of the vehicle.

### TECHNICAL FIELD

The invention relates to a reserve dry sump oil tank assembly for use in a motor vehicle. More particularly, it relates to providing additional volume for increased oil flow during certain vehicle operating conditions.

### BACKGROUND OF THE INVENTION

Lubrication systems for internal combustion engines on passenger vehicles may be wet or dry sump lubrication systems. A wet sump lubrication system is typically used on production vehicles. Lubricant is stored beneath the crankshaft and oil pan. The oil pan needs to be large and deep in order to hold sufficient amounts of lubricant, such as oil, to lubricate the engine.

Dry sump lubrication systems utilize an external tank to store some of the oil outside of the engine. Accordingly, a large and deep oil pan under the engine is not required and the engine may be placed lower in the vehicle. Dry sump lubrication systems are commonly used with high-performance engines, such as racing vehicles.

In vehicles with a dry sump lubrication system, oil is pumped from the external oil tank to the parts of the engine that require lubrication. Oil thrown from the crankshaft bearings during operation drains to the sump located in a lower part of the crank case. Oil received in the sump is pumped back to the oil tank by a scavenge pump. Due to packaging considerations the oil tank is often of limited size and volume.

### SUMMARY OF THE INVENTION

A dry sump oil tank assembly is provided for lubricating an engine, and is suitable for a high performance vehicle, such as a racing vehicle or for a standard passenger vehicle that may occasionally be subjected to high-performance conditions.

The dry sump oil tank assembly includes a main oil tank that defines a main outlet aperture. A reserve oil tank defines a reserve outlet aperture. An oil transfer tube connects the main oil tank at the main outlet aperture to the reserve oil tank at the reserve outlet aperture. The reserve oil tank is shaped to fit between a frame rail and a fender of the vehicle.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view illustration of a dry sump oil tank assembly;

FIG. 2 is a schematic perspective illustration in fragmentary view of the dry sump oil tank assembly of FIG. 1 in a vehicle viewed from the front of the vehicle looking rearward;

FIG. 3 is a schematic perspective illustration in fragmentary view of the dry sump oil tank assembly of FIGS. 1 and 2 in a vehicle viewed from the rear of the vehicle looking forward;

FIG. 4 is a schematic perspective illustration in fragmentary view of the dry sump oil tank assembly of FIGS. 1-3 in a vehicle viewed from the top of the vehicle looking downward; and

FIG. 5 is a schematic perspective illustration in fragmentary view of the dry sump oil tank assembly of FIGS. 1-4 in a vehicle viewed from the passenger compartment of the vehicle.

### DESCRIPTION OF THE PREFERRED EMBODIMENTS

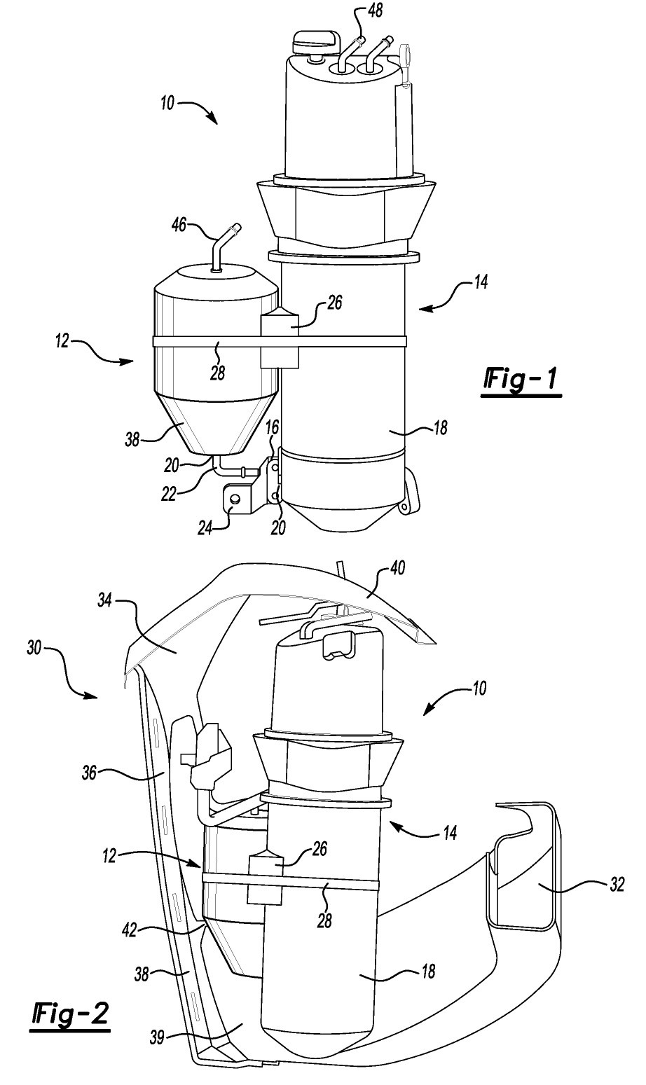

Referring to the drawings wherein like reference numbers refer to like components, FIG. 1 shows a dry sump oil tank assembly 10. The assembly includes a reserve oil tank 12 and a main oil tank 14. A pump assembly (not shown) forces oil from the engine (not shown) to the main tank 14. Additionally, oil from a lower housing portion 18 on the main oil tank 14, is returned to the engine via a main oil outlet (not shown). The main oil tank 14 has an additional main outlet aperture 16 defined by the lower housing portion 18. The reserve oil tank 12 has a reserve outlet aperture 20. The reserve outlet aperture 20 is fluidly connected to the main outlet aperture 16 with an oil transfer tube 22. The oil transfer tube 22 allows oil to enter and leave the reserve oil tank 12 and the main oil tank 14. The oil entering the main oil tank 14 from the reserve oil tank 12 mixes with the oil stored in the main oil tank 14.

A mounting bracket 24 is mounted to the main oil tank 14. The mounting bracket 24 is used to assemble the dry sump oil tank assembly 10 in the vehicle 30 (shown in FIG. 2). The mounting bracket 24 can be connected to the main oil tank 14 through welding, fasteners or the like.

The reserve oil tank 12 also includes a reserve connector 46 extending upward from the reserve oil tank 12. The reserve connector 46 may be connected to a main connector 48 on the top of the main oil tank 14 via fluid piping or the like. The main connector 48 is preferably a semi-fresh line for operation of the main oil tank 14. The reserve connector 46 and the main connector 48 are in fluid communication to equalize pressure between the reserve oil tank 12 and the main oil tank 14. The main connector 48 may be further connected to the engine (not shown) to equalize pressure therebetween.

A bracket 26 assists in securing and aligning the reserve oil tank 12 to the main oil tank 14. Additionally a strap 28 may be used to secure and align the reserve oil tank 12 to the mail oil tank 14. Both the reserve oil tank 12 and the main oil tank 14 may be attached to the bracket 26 through welding, fasteners or the like.

The reserve oil tank 12 provides additional oil storage for the main oil tank 14. In the example embodiment shown, the reserve oil tank 12 has a 3 quart volume, including oil and air volumes. The additional volume for oil storage addresses the phenomenon of “draw down” where an operating level of the oil is higher within the dry main oil tank 14 when the vehicle is not in use, but is lowered when in use, as the oil is routed through the entire lubrication system. Severe draw down will cause the operating level of the oil to be insufficient, such that the main oil outlet (not shown) to the engine may be uncovered during high speed maneuvers, resulting in an undesirable drop in oil pressure. With an increased oil volume enabled by the reserve oil tank 12, even with draw down, the in-use oil operating level is high enough such that the main oil outlet does not become uncovered. The dry sump oil tank assembly 10 is thus also suited for a vehicle that may be typically used in standard driving conditions, but occasionally subjected to high performance use.

Referring to FIG. 2, the oil tank assembly 10 is shown in an example vehicle 30 from the front of the vehicle 30 looking toward the rear of the vehicle 30. Portions of the vehicle have been removed to easily view the oil tank assembly 10. The oil tank assembly 10 is located between a vehicle frame 32 and a vehicle fender 34. The oil tank assembly 10 is outward of the vehicle frame 32 and inward of the vehicle fender 34 from the perspective of the vehicle 30. A typical clearance for the reserve oil tank 14 is 15 mm from the frame 32 and 30 mm from the vehicle fender 34. As is evident in FIG. 2 at least a portion of the frame 32 runs fore and aft (i.e. longitudinally) in the vehicle.

The oil tank assembly 10 is also located forward in the vehicle of a door hinge pillar 36. That is, the oil tank assembly 10 is located closer to the front of the vehicle 30 than the door hinge pillar 36. The reserve oil tank 12 is located rearward in the vehicle 30 of the main oil tank 14.

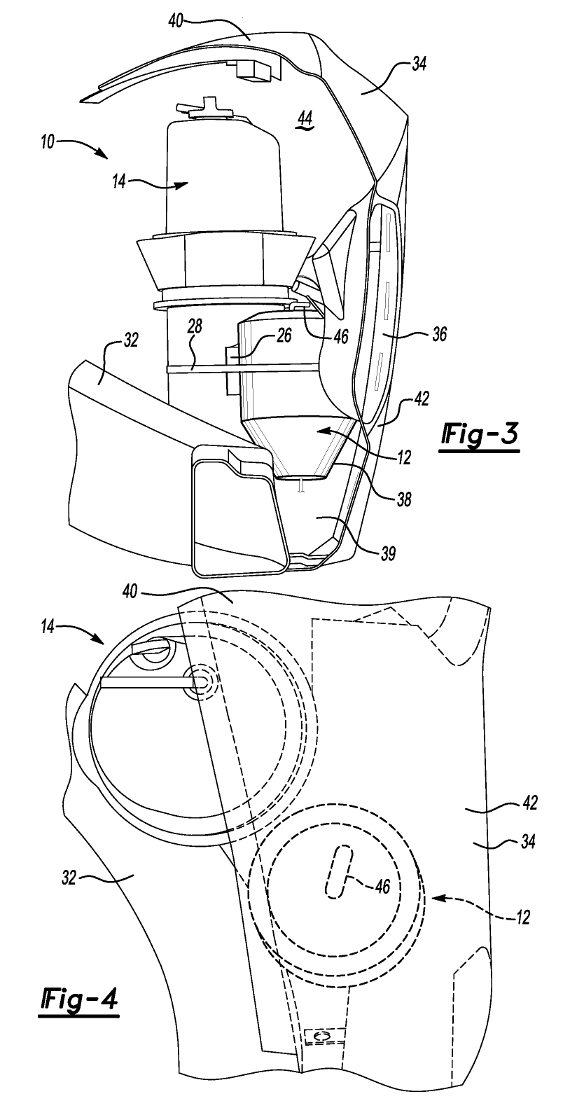

Referring to FIG. 3, the oil tank assembly 10 is shown in the example vehicle 30 from the rear of the vehicle 30 looking toward the front of the vehicle 30. Portions of the vehicle have been removed to easily view the oil tank assembly 10. The oil tank assembly 10 is located between the vehicle frame 32 and the vehicle fender 34. The reserve oil tank 12 has an angled lower portion 38 to fit in the space 39 defined by the vehicle frame 32 and the vehicle fender 34.

The oil tank assembly 10 is located forward in the vehicle 30 of the door hinge pillar 36. The door hinge pillar 36 is commonly referred to as an A-pillar. The A-pillar is the structural member that supports the forward vehicle doors. The A-pillar also commonly supports the vehicle windshield. An engine compartment wall (not shown) is can be mounted to the door hinge pillar 36. Thus, the oil tank assembly is located forward of the engine compartment wall such that the oil tank assembly 10 is separated from and forward of a passenger compartment of the vehicle 30.

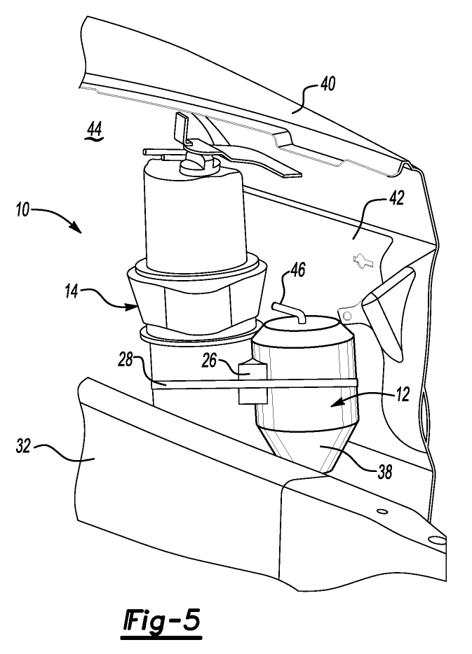

The vehicle fender 34 defines a space 44 to allow for a wheel to be mounted on the vehicle under the vehicle fender 34. The space 44 is commonly known as the wheel well. The oil tank assembly 10 is located rearward in the vehicle 30 of the space 44. This can be seen more clearly in the perspective view of FIG. 5.

FIG. 4 illustrates a top view of the oil tank assembly 10 in the vehicle 30. An upper portion of the fender 34 forms a fender inner panel 40 which partially covers the oil tank assembly 10. The main oil tank 14 is visible from the hood compartment of the vehicle 30. However, the reserve oil tank 12 is covered by the fender inner panel 40. The oil tank assembly 10 is located between the vehicle frame 32 and a side 42 of the vehicle fender 34.

FIG. 5 illustrates a schematic perspective view of the oil tank assembly 10 in the vehicle 30 looking from a passenger compartment of the vehicle 30. Again, portions of the vehicle have been removed to easily view the oil tank assembly 10. From the angle shown the vehicle frame 32 passes in front of the oil tank assembly 10 and the fender 34 passes behind and above the oil tank assembly 10. That is, the oil tank assembly 10 is inward on the vehicle 30 from the fender 34 and outward on the vehicle 30 from the vehicle frame 32. The fender inner panel 40 of the fender 34 is shown above the oil tank assembly 10. As shown, the oil tank assembly 10 is located rearward in the vehicle 30 of the wheel well or space 44.

As discussed above, the dry sump oil tank assembly 10 is particularly useful for high performance applications, such as racing vehicles, and may utilize components from standard vehicle applications, thus maximizing the economies of scale of producing such components and being suited for a vehicle that may be typically used in standard driving conditions, but occasionally subjected to high performance use.

While the best modes for carrying out the invention have been described in detail, those familiar with the art to which this invention relates will recognize various alternative designs and embodiments for practicing the invention within the scope of the appended claims.

1. A dry sump oil tank assembly for a vehicle having a frame rail and a fender, comprising:
a main oil tank defining an oil outlet aperture;
a reserve oil tank defining a reserve outlet aperture; and
an oil transfer tube fluidly connecting the main oil tank at the main outlet aperture to the reserve oil tank at the reserve outlet aperture, wherein the reserve oil tank is shaped to fit between the frame rail and the vehicle fender.

2. The dry sump oil tank assembly of claim 1, wherein the vehicle has a vehicle door hinge pillar and wherein the reserve oil tank is shaped to fit forward of the vehicle door hinge pillar.

3. The dry sump oil tank assembly of claim 1, wherein the vehicle fender defines a wheel well and wherein the reserve oil tank is shaped to fit rearward of the wheel well.

4. The dry sump oil tank assembly of claim 1, wherein the vehicle fender extends upward to cover at least a portion of the reserve oil tank when assembled in the vehicle.

5. The dry sump oil tank assembly of claim 1, wherein the reserve oil tank further includes an angular lower portion.

6. The dry sump oil tank assembly of claim 1, wherein the reserve oil tank includes a reserve connector and the main oil tank includes a main connector, and the reserve connector, the main connector are in fluid communication to equalize pressure between the reserve oil tank and the main oil tank.

7. The dry sump oil tank assembly of claim 1, further comprising a bracket extending from the main oil tank, wherein the reserve oil tank is mounted to the bracket to support the reserve oil tank with the main oil tank.

8. A dry sump oil tank assembly for a vehicle having a frame and a fender comprising:
a main oil tank defining an oil outlet aperture;
a reserve oil tank defining a reserve outlet aperture;
an oil transfer tube fluidly connecting the main oil tank at the main outlet aperture to the reserve oil tank at the reserve outlet aperture, wherein the reserve oil tank includes a lower portion shaped to fit in a space defined between the vehicle frame and the vehicle fender; and
a bracket extending from the main oil tank, wherein the reserve oil tank is mounted to the bracket to support the reserve oil tank with the main oil tank.

9. The dry sump oil tank assembly of claim 8, wherein the vehicle has a vehicle door hinge pillar, and wherein the main oil tank and the reserve oil tank are shaped to fit between the vehicle frame and the vehicle fender and are located forward of the vehicle door hinge pillar.

10. The dry sump oil tank assembly of claim 9, wherein the vehicle fender defines a wheel well, and wherein the main oil tank and the reserve oil tank are shaped to fit rearward of the wheel well.

11. The dry sump oil tank assembly of claim 9, wherein the vehicle fender extends upward to cover at least a portion of the reserve oil tank when assembled in the vehicle.

12. The dry sump oil tank assembly of claim 8, wherein the reserve oil tank includes a reserve connector, the main oil tank includes a main connector, and the reserve connector and the main connector are in fluid communication to equalize pressure between the reserve oil tank and the main oil tank.

13. A vehicle comprising:
a dry sump oil tank assembly having a main oil tank and a reserve oil tank, wherein the main oil tank is fluidly connected to the reserve oil tank;
a frame rail located on a first side of the dry sump oil tank assembly; and
a vehicle fender located on a second side of the dry sump oil tank assembly.

14. The vehicle of claim 13, wherein the vehicle has a vehicle door hinge pillar, and wherein the main oil tank and the reserve oil tank are located forward of the vehicle door hinge pillar.

15. The vehicle of claim 14, wherein the vehicle door hinge pillar is an A-pillar.

16. The vehicle of claim 13, wherein the vehicle fender defines a wheel well, and wherein the main oil tank and the reserve oil tank are located rearward of the wheel well.

17. The vehicle of claim 13, wherein the vehicle fender extends upward to cover at least a portion of the reserve oil tank.

18. The vehicle of claim 13, wherein the reserve oil tank includes a lower portion shaped to fit in a space defined by the vehicle frame and the vehicle fender.

19. The vehicle of claim 13, further comprising a bracket extending from the main oil tank, wherein the reserve oil tank is mounted to the bracket to support the reserve oil tank with the main oil tank.

20. The vehicle of claim 13, wherein the reserve oil tank includes a reserve connector, the main oil tank includes a main connector, and the reserve connector and the main connector are in fluid communication to equalize pressure between the reserve oil tank and the main oil tank.
